(19) United States
(12) Patent Application Publication
(10) Pub. No.: US 2015/0339691 A1
(43) Pub. Date: Nov. 26, 2015

(54) Systems and Methods for Adjusting Prices for a Service

(71) Applicant: MOOSE LOOP HOLDINGS, LLC, Salt Lake City, UT (US)

(72) Inventors: Ken R. Davis, Salt Lake City, UT (US); Fraser M. Smith, Salt Lake City, UT (US)

(73) Assignee: MOOSE LOOP HOLDINGS, LLC, Salt Lake City, UT (US)

(21) Appl. No.: 14/286,437

(22) Filed: May 23, 2014

(51) Int. Cl. G06Q 30/02; G06Q 10/10

(52) U.S. Cl. CPC G06Q 30/0206; G06Q 10/109

(57) ABSTRACT

A method for adjusting market pricing terms for a service comprises determining a statistical distribution of schedule availability of a first tier of service providers, the first tier of service providers being selected from a plurality of tiers of service providers. A target statistical distribution of schedule availability of service providers of a service is determined. Market pricing terms charged by service providers in the first tier of service providers are adjusted to adjust the statistical distribution of schedule availability relative to the target statistical distribution of schedule availability.

### BACKGROUND

Many goods can be purchased in a commoditized way. A consumer can have certain criteria when deciding to purchase a good and if the good meets the desired criteria, then the consumer generally does not care who provides the good, making the good in some senses a commodity. A market offering to sell the good also adds to the senses in which the good can be considered a commodity. Additionally, the market can establish a fixed price for the good, at which the good can be obtained without bargaining, bidding, or auction.

Services have traditionally been less commoditized. Rather, services are typically purchased after comparing service providers to one another. For example, service providers can be compared through a bidding process, interviews, and/or online customer feedback ratings. Even such service provider comparisons can be challenging for a consumer to interpret due to the non-uniformity in services supplied by various service providers. This has resulted in uncertainty to the consumer as to the comparative cost of services, reliability of services, and the quality of services provided by service providers.

### BRIEF DESCRIPTION OF THE DRAWINGS

FIG. 1 is a block diagram illustrating an example of a system for commoditizing services and/or generating a commoditized service market to offer commoditized services.

FIG. 2 is a chart illustrating an example of a customer selecting a potential service from potential service categories for commoditization.

FIG. 3A is a chart illustrating an example of pooling service providers to provide a virtual market for a customer-selected service and illustrates examples of sources of information used to generate task details that differentiate levels of work associated with one instance of a particular service as opposed to another.

FIG. 3B is a chart illustrating an example of pooling service providers into tiers, the service providers in each tier having similar performance characteristics.

FIG. 4 illustrates an example of acquiring information about a given instance of a customer-selected service used to quantize task details to determine quantities, levels, or an amount of work associated with a given instance of the customer-selected service.

FIG. 5 is a chart illustrating an example of compiling statistical pricing information related to the task details for a given customer-selected service from a plurality of service providers.

FIG. 6 is a flowchart illustrating an example of using acquired information with statistical pricing information to commoditize a given customer-selected service, assign a market price, and/or fixed prices for the given customer selected service.

FIG. 7 is a block diagram illustrating an example of additional pricing functionality modules that can be used to adjust a market price for a given customer-selected service to produce a fixed price.

FIG. 8 is a block diagram illustrating an exemplary system for adjusting market pricing terms for commoditized services.

FIG. 9 is a flowchart illustrating an exemplary method for adjusting market pricing terms for commoditized services.

FIG. 10 is an exemplary chart showing a statistical distribution of service provider availability.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure are to be considered within the scope of the description.

A technology is described for efficiently providing access to services at fixed prices via a networked computer system. Throughout this application, the term network can comprise a network implemented over wires, cables, fibers and/or the like and/or a wireless network. By way of example and not limitation, such a wireless network can include a Wireless-Fidelity (Wi-Fi) network and/or a wireless network for mobile communications. More accurate and efficient access to services can be used to commoditize services not commoditized in the past by allowing the services to be priced and delivered in a more uniform fashion. Such access can be provided by operations implemented in networking and computing device hardware, such as generating a market of service providers for a customer-selected service from a pool of service providers, acquiring information about services over a network that is tailored to those service providers, and/or applying statistical pricing information from those service providers and/or additional sources. Additionally, operations, as discussed below, can also be implemented to improve access to services at fixed prices.

While access can be provided for any of a nearly limitless number of services provided by service providers, examples of commoditization of services can be applied to many areas including, by way of example and not limitation, property management services, such as: tenant evictions, painting, landscaping, repairs, and property inspections. Another non-limiting example of such a service area can include various yard and home services, such as: lawn mowing, lawn fertilizing, basic home repairs, painting, cleaning, gardening, small appliance repair, etc. A service provider can be any service provider, contractor, service contractor, service group, or service supply entity that provides a service to a customer.

This technology can enable a customer to select a service or task (e.g., lawn mowing) to be purchased electronically at a fixed price. A GUI (GUI) on a client device can present choices to the customer of a variety of different services offered. A market of service providers offering to provide a customer-selected service can be generated by selecting a sub-pool, or plurality, of service providers capable of performing a customer-selected service from previously screened service providers in a data store.

The GUI can also be used to acquire service information from the customer about a customer-selected service. As discussed in more detail below, the service information can be acquired from one or more additional sources. The service information acquired from the customer and/or additional source(s) can relate to task details that comprise parameters, or variables, specific to a given service that differentiates levels of work associated with the performance of that type of service. The terms service and task can be used interchangeably in this description. The service information acquired from the customer and/or additional source(s) may be tailored to the sub-pool of service providers and/or the previously screened service providers in the data store. Additionally, the information can comprise quantitative values for these details, parameters and variables.

The service information can be applied to remove variables that accompany the task details specific to the customer-selected service. The customer-selected service can, thereby, be reduced to an undifferentiated commodity of work. Statistical pricing information from the sub-pool of service providers, the previously screened service providers, and/or other sources can be applied to the undifferentiated commodity of work to assign a market price for the customer-selected service.

The statistical pricing information can pertain to various task details. By applying statistical pricing from the sub-pool of service providers, the market price can reflect a market generated for the customer-selected service. Further costs, such as service provider costs and a transaction fee, can be added to the market price to generate a fixed price. The fixed price can be presented to the customer over the GUI, at the point of sale, and allow the customer to complete a transaction immediately, without further bargaining, bidding, auctioning, or the like. Additional operations, discussed below, can also be implemented to refine the market and/or fixed price and/or provide additional functionality.

Using a commodity approach can simplify the service purchase process and can make buying services more analogous to buying tangible goods through a retail store. Additionally, such a commodity approach can lower by creating a competitive services market. Such a market can be made to constantly refine itself to react to new information. At the same time, the value provided to service providers can be increased by: removing advertising costs; providing more customers; assigning customers situated closer together; automating pricing, providing back office accounting and management functions; and, providing other benefits that improve service provider efficiency and/or boost service provider revenues.

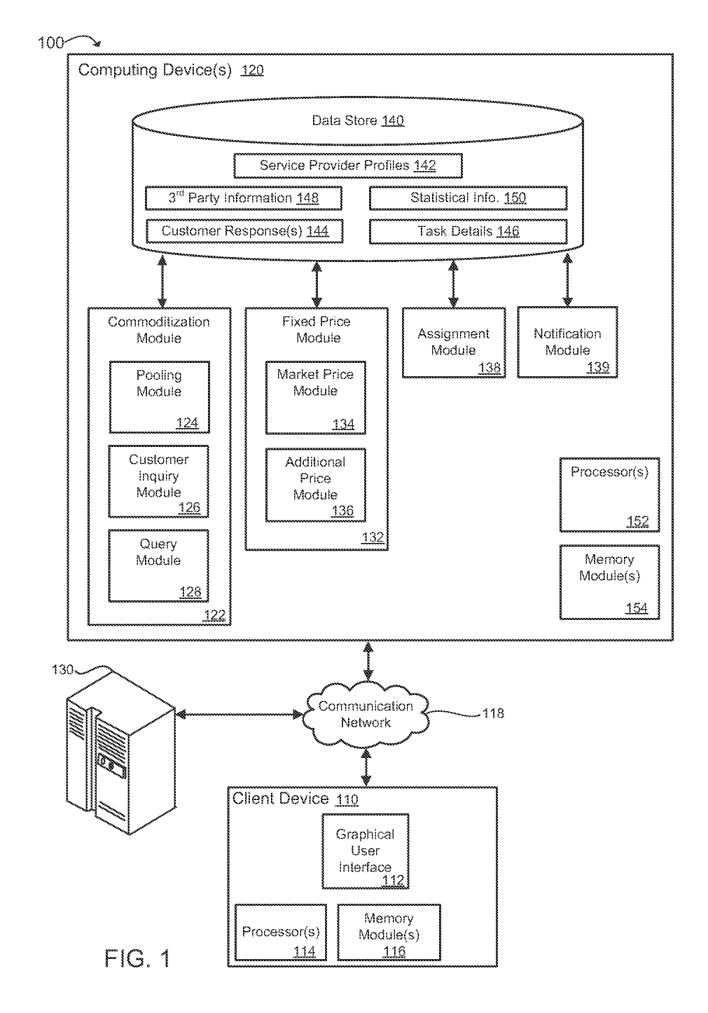

As illustrated generally in FIG. 1, a system 100 can be used for commoditizing services and/or generating a commoditized service market to offer commoditized services. The system 100 can include a client device 110 through which a customer can access information related to tasks and customers over a communications network 118. The communications network 118 can be a local area network (LAN), wide area network (WAN), or the Internet. A GUI 112 can be provided to the customer at the client device 110 to access information located on a separate computing device 120, with a processor(s) 152 and memory module(s) 154.

A processor(s) 114 and a memory module(s) 116 can be included with the client device 110. The client device 110 can be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that can present the GUI 112. The client device 110 with a GUI 112 can be used by either a service provider or a customer.

The GUI 112 can provide the customer with several options for services. Once a customer selects a service, a commoditization module 122 within the computing device(s) 120 can begin to perform operations to enable the customer-selected service to be treated like a commodity. For example, a pooling module 124, in communication with the commoditization module 122, can select a pool of service providers from a set of service provider profiles 142. Throughout this application, the term ‘set’ can include potential sets with zero elements, with a single element, and with multiple elements. Profiles for the pre-screened service providers 142 can be stored in a data store 140 in communication with the computing device(s) 120.

The data store 140 can refer to any device or combination of devices capable of storing, accessing, organizing, and/or retrieving data, which can include any combination and number of data servers, relational databases, object oriented databases, simple web storage systems, distributed storage systems, data storage devices, data warehouses, flat files, and data storage configuration in any centralized, distributed, or clustered environment. The storage system components of the data store can include storage systems such as a SAN (Storage Area Network), cloud storage network, volatile or non-volatile RAM, optical media, or hard-drive type media.

The service provider profiles 142 can be generated during pre-screening of a service provider, during which provider information about a given service provider can be obtained for several categories. Examples of such categories can include, without limitation, different services a service provider is capable of performing, different levels of quality at which a service provider is capable of performing those services, pricing information for a service provider, discussed in more detail below, and logistical information. Several categories of additional information can be acquired, but the foregoing examples serve for purposes of illustration. With respect to the logistical information, such information can include information about a service provider's current location and availability, which can be continually updated. In certain examples, a service provider agrees to perform a service for which the service provider has been screened at a fixed price determined by the system in exchange for receiving a profile.

The pooling module 124 can pool the service providers on the basis of capability to perform the customer selected service. Several additional (or alternative) factors can also be considered, such as quality. In certain examples, logistical considerations can be factored into the pool. However, in alternative examples, logistical considerations may be considered after pooling of service providers and after a fixed price has been determined as a way of assigning the customer-selected service to a particular service provider. In some examples, logistical considerations can play a role at both the pooling and assignment stages.

As discussed in more detail below, the pooling module 124 can also pool members of the plurality of service providers into one or more tiers, or rated groups, of service providers. While not so limited, in one example, each service provider in a particular tier can exhibit, or have proven performance attributes similar to other members of the tiers. Performance attributes can include, without limitation, quality of work of the service provider; experience of the service provider; tenure of the service provider; timeliness of the service provider; user ratings relating to the service provider; and audit findings relating to the service provider. In this manner, tiers of service providers can be created that represent a desired level of performance of service providers, with or without regard to a market price charged by the members of the pool.

By pooling the service providers for the customer, the pooling module 124 can create a potential market for the customer-selected service. By pooling multiple service providers, the pooling module 124 can lower the potential cost to the customer of having the service performed. However, additional issues arise in the treatment of the customer-selected service as a commodity, as will be explained.

One reason that services can elude commodity-like treatment is that multiple instances of the same service can vary in a variety of ways. For example, a number of rooms can greatly alter the amount of work involved with providing a service in terms of carpet cleaning. The difficulty of service providers in accommodating such variability with uniform pricing typically means that service providers provide bids or quotes, work on an hourly basis, or provide services on a flat fee within broadly defined parameters, hoping that large volumes can even out inevitable differences. Where this can be true of comparatively simple services, like lawn mowing, the problem can be much more pronounced for more complicated services. Such variables differentiate a quantity of work applied to perform one instance of a particular service in ways that result in inefficiencies and barriers to transactions for services. As used herein, the term “quantity of work” can comprise differences in both quantity and kind of services.

On the service provider's side, there are inefficiencies involved in advertising, looking for customers, preparing bids, tailoring prices to different levels of service, and the like. On the customer's side, resources in terms of time and effort spent acquiring education about cost variables, searching out different service providers, and comparing those service providers may be mitigated using this technology. These inefficiencies and barriers to transactions can be traced, to a significant degree, to the variables that differentiate one instance of performing a particular service from another.

The undifferentiated nature of commodities may make them fungible in a way that removes inefficiencies and barriers to transactions. With a good, since the good is interchangeable, the provider can become less relevant. A purchaser does not need to shop providers, but only needs to determine whether a fixed price, determined by a market of multiple providers, is acceptable. A seller is also less likely to invest large sums in creating a market for the commodity the seller produces, rather the seller can focus on providing the commodity to the market. Therefore, inefficiencies and barriers to transactions associated with service transactions can, in large part, be mitigated by assigning values to the variables that differentiate services in ways that allow the services to be defined as undifferentiated quantities of work that can be treated like commodities.

Assigning values to the variables inherent in a customer-selected service can be achieved by determining variables for several different services, which include the customer-selected service, and acquiring information about those variables. The variables, or parameters, can be determined with a wide range of granularities for a number of different potential services in terms of service-specific task details 146. The task details 146 can be defined for various services offered to the customer and can be stored within a data store 140 in communication with the computing device(s) 120.

In certain examples, the task details 146 can be determined, at least in part, by statistical data provided by, or considerations important to, the service providers described by the set of service provider profiles 142. The task details 146 can also be determined by external statistical data and sources for considerations related to the performance of various types of services. Furthermore, the task details 146 can be defined in ways such that quantitative values can be assigned to define the underlying variables. For variables that are essentially qualitative in nature, such as quality of service, different quantitative levels can be defined. The commoditization module 122 can retrieve task details 146 specific to the customer-selected service to facilitate acquisition of information about the task details 146 answering to the customer-selected service.

Examples of these task details 146, provided by way of illustration and not limitation, can include one or more of the following parameters, or variable details: time since last service performed, square dimensions of project, current state or quality of project, desired state or quality of project, number of hours service can be performed, distance to be traveled, number of units to be transported, average amount of time similar jobs have historically consumed, average cost of parts similar jobs have historically consumed, number of levels or stories of a structure, number of rooms in a structure, square dimensions of a structure, the presence of exterior improvements such as a swimming pool, hot tub or basketball court, the desired start date, the desired completion date, whether a specific time or an approximate time is desired for performance of the service, the number of legal steps required by law, the grade or style of materials used, the frequency of recurrence, the depth or quantity of material to be moved or removed, the linear dimensions of the project, etc.

Information about the variables in a given set of task details 146 can be acquired by a customer inquiry module 126, in communication with the commoditization module 122. The customer inquiry module 126 can communicate inquiries (e.g., questions) to the customer at the client device 110 over the network 118. The customer inquiry module 126 can formulate the inquiries, or questions, to provide values for the set of task details 146 corresponding to the customer-selected service. These inquiries, or questions, can be formulated to request quantitative values. The GUI 112 at the client device can serve as the interface for communicating the inquiries, or questions, and collecting corresponding customer response(s) 144, which can be stored by the customer inquiry module 126 in the data store 140. In some examples, the customer response(s) 144 can be utilized directly in the commoditization module 122.

In many instances, it can be desirable to acquire information from one or more sources other than the customer or a service provider. Such third-party information 148 can be acquired in addition to, or in place of, customer response(s) 144. This third-party information 148 can provide information not readily obtainable by the customer and/or verify information obtained by customer response(s) 144. A query module 128, in communication with the commoditization module 122, can acquire the third-party information 148, which may be stored in the data store 140.

The query module 128 can acquire the third-party information 148 over the network 118 from one or more third-party sources. One non-limiting example of such a source can include a server 130 connected to the network 118. Such a server 130 can provide access to public and/or private data stores.

The commoditization module 122 can apply the customer response(s) 144 and/or the third-party information 148 to the task details 146. For each task detail of the customer-selected service to which customer response(s) 144 and third-party information 148 is applied by the commoditization module 122, potential differences in a quantity of work associated with the customer-selected service can be clarified. As potential differences are clarified, the commoditization module 122 may more clearly define the customer-selected service as an undifferentiated quantity of work to be performed. As the customer-selected service becomes an undifferentiated quantity of work to be performed, inefficiencies and transaction barriers can be removed. In certain examples, quantitative values from the customer response(s) 144 and/or the third-party information 148 are applied to the task details 146 toward the enablement of the treatment of the customer-selected service as a commodity. In some examples, task details 146 not addressed can be ignored.

To further enable the treatment of the customer-selected service as a commodity, a fixed pricing module 132 can assign a fixed price to the customer-selected service after the service has been reduced to an undifferentiated quantity of work. A market price module 134, in communication with the fixed price module 132, can first establish a market price for the customer-selected service. Statistical information 150 about levels of work associated with the performance of a service can also be used to establish a market price. This statistical information 150 can be retrieved from the data store 140 by the fixed price module 132 and/or the market price module 134.

The statistical information 150 can include different sub-sets of information for different services offered to a customer over the GUI 112. Each sub-set can further be subdivided into statistical information answering to different service-specific task details 146. The statistical information 150 can provide quantitative values for prices answering to different values for different service-specific task details 146 and/or different combinations of different service-specific task details 146 for one or more service providers. Additionally, or in the alternative, such statistical information 150 can provide quantitative values for time, opportunity costs, fuel, materials, overhead, other business costs, and/or profit margins associated with performing different service-specific task details 146 and/or different combinations of different service-specific task details 146 for one or more service providers.

The statistical information 150 can comprise statistical information from service providers with service provider profiles 142 and/or service providers without service provider profiles 142. In certain examples, the statistical information 150 can initially come from service providers without service provider profiles 142. However, over time, the statistical information 150 can be replaced and/or augmented, as discussed in greater detail below, with statistical information 150 from service providers with service provider profiles 142. The statistical information 150 can also include additional information helpful in establishing a market price for various services from private and/or public data files, which may be archived on the data store, and/or accessible over the network 118 by the computing device(s).

The market price module 134 can establish a market price for the pool of service providers selected for a customer-selected service by applying statistical information 150 specific to the task details 146 for the customer-selected service, where potential differences and variability associated with those task details has been mitigated by the application of customer response(s) 144 and/or third party information 148. Once a market price has been established, the customer-selected service can be treated like a commodity and offered to the customer at a fixed price. However, in many examples additional costs can be added to the market price to establish the fixed price.

An additional price module 136, in communication with the fixed price module 132 and/or the market price module 134 can apply relevant additional costs. An example of such a cost can include a transaction cost associated with the overall system 100 and the commoditization process. For example, a significant portion of the retail fixed price charged to the customer can be paid to the service provider and a smaller portion of the fixed price can be retained by the entity operating the technology described in this description. Additional examples are discussed in greater detail below. Once a fixed price has been established, a notification module 139, in communication with the fixed price module 132 can communicate the fixed price over the network 118 to the customer. This communication can be facilitated by the GUI 112 at the client device 110. The customer can immediately complete the transaction, without further significant bargaining, bidding, auctioning, or the like, by accepting the fixed price via the GUI 112.

In addition to establishing a fixed price for a customer selected service, a service provider from the pool of service providers can also be assigned to perform the customer-selected service by an assignment module 138. The assignment module 138 can assign, or select, a service provider based on predefined criteria. Such predefined criteria can include, by way of example and not limitation, distance between a service provider and a customer, time slots made available by the service provider, a skill level of service requested, previous, performance feedback of the service provider from prior customers, tier of a service, provider, etc. Other criteria or metrics about service providers may also be used in assigning, or selecting a service provider, as desired. The customer and the service provider can be notified of the service provider using the notification module 139, which can also be in communication with the assignment module 138.

The notification module 139 can also notify the service provider over the network 118. In addition to using a GUI 112, the notification module 139 can prepare a web page or a web application page to be sent to the customer and/or service provider.

As additional non-limiting examples, emails, instant messages, text messaging, or any other message type that can be sent by the notification module 139 to the customer and/or service provider. The notification module 139 can also prepare other network pages, web pages, or web application pages to communicate other information to the client device 110. Additional details related to the various elements discussed above are now discussed with respect to additional drawings.

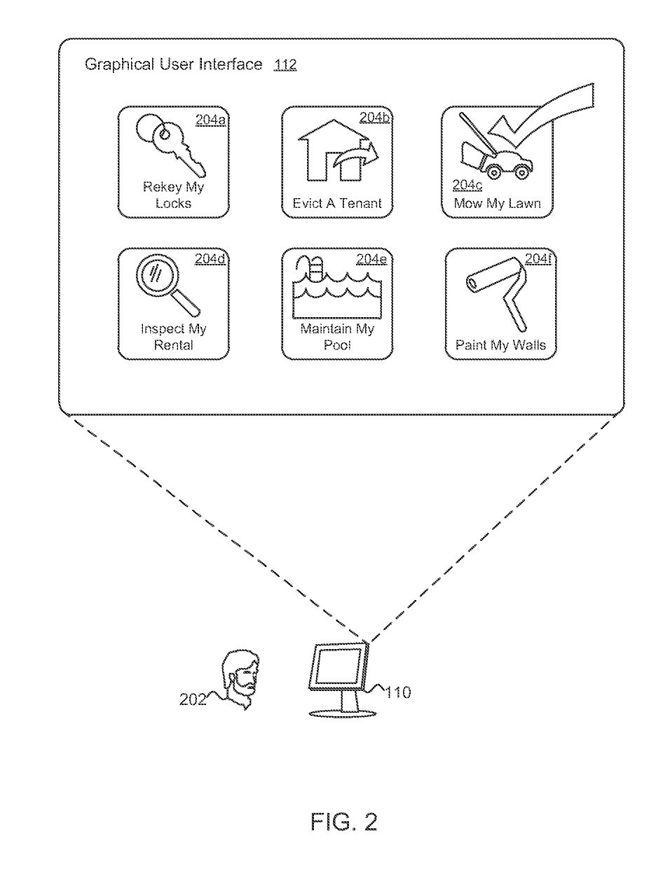

FIG. 2 illustrates an example of a customer selecting a potential service from potential service categories for commoditization. A customer 202 is depicted at a client device 110. The client device displays a GUI 112 to the customer. The GUI 112 can present several service options 204a-f to the customer 202. Non-limiting examples of such options can include services to: re-key rental or other property locks 204a; evict a tenant 204b; mow a lawn 204c; inspect a rental 204d; maintain a pool 204e; and/or paint walls 204f. Additional non-limiting examples can include: lawn aeration; lawn fertilization; tree pruning; sprinkler repair; snow removal; roof gutter cleaning; fall clean-up; spring clean-up; window washing; small appliance repairs; HVAC repairs; filter changing; handyman projects; pest control; window washing; house cleaning; carpet cleaning; and/or garbage collection. As can be appreciated, examples of potential services are virtually limitless.

In the example depicted in FIG. 2, the customer has selected the service of a lawn mow 204c, as indicated by the check mark. Once the customer-selected service is selected and communicated to the computing device(s) 120, discussed with respect to FIG. 1, over the network 118, a fixed price can begin to be established. A first step in establishing a fixed price can involve pooling potential service providers to create a market for the customer-selected service.

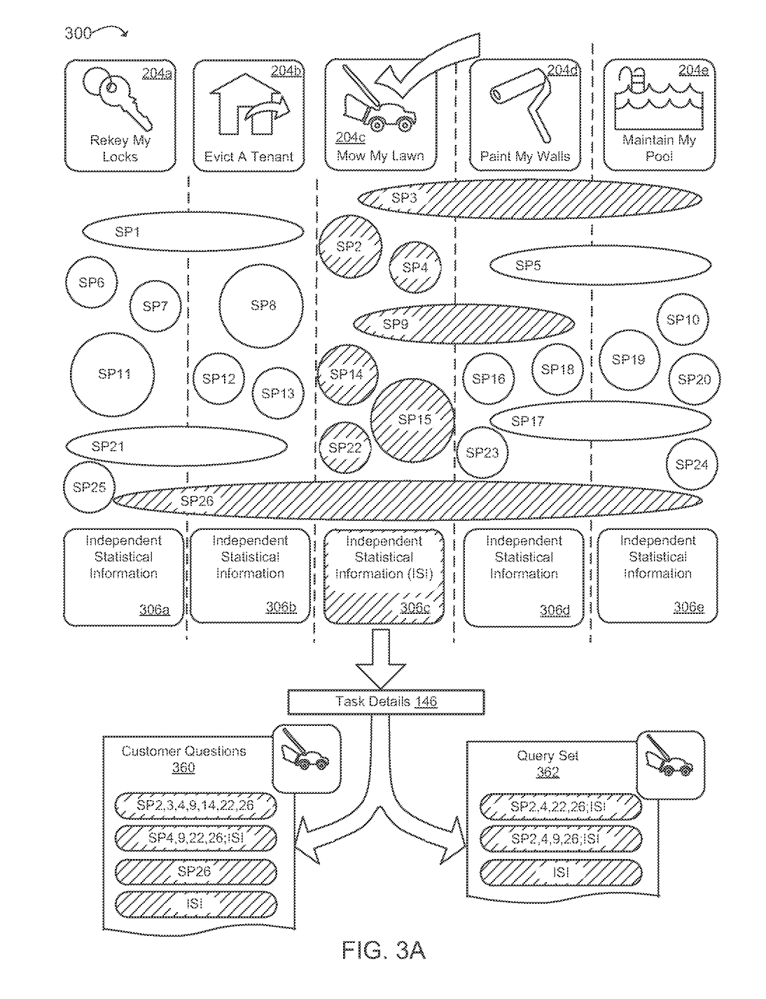

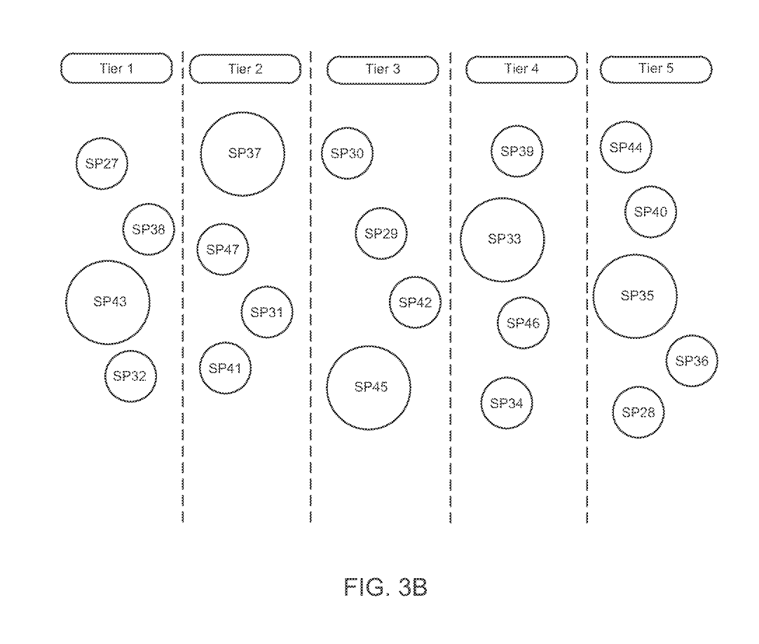

FIG. 3A illustrates an example of pooling service providers to begin to provide a virtual market for the customer-selected service. In FIG. 3A, several service options 204a-e similar to those depicted in FIG. 2 are placed at the top of a chart 300 including several service providers SP1-SP26. The circles and ellipses used to represent service providers SP1-SP26 can comprise service provider profiles 142, or portions thereof, similar to those discussed with respect to FIG. 1. Additionally, or in the alternative, the circles and ellipses used to represent service providers SP1-SP26 can also comprise statistical information 150 associated with the service providers SP1-SP26, or portions thereof.

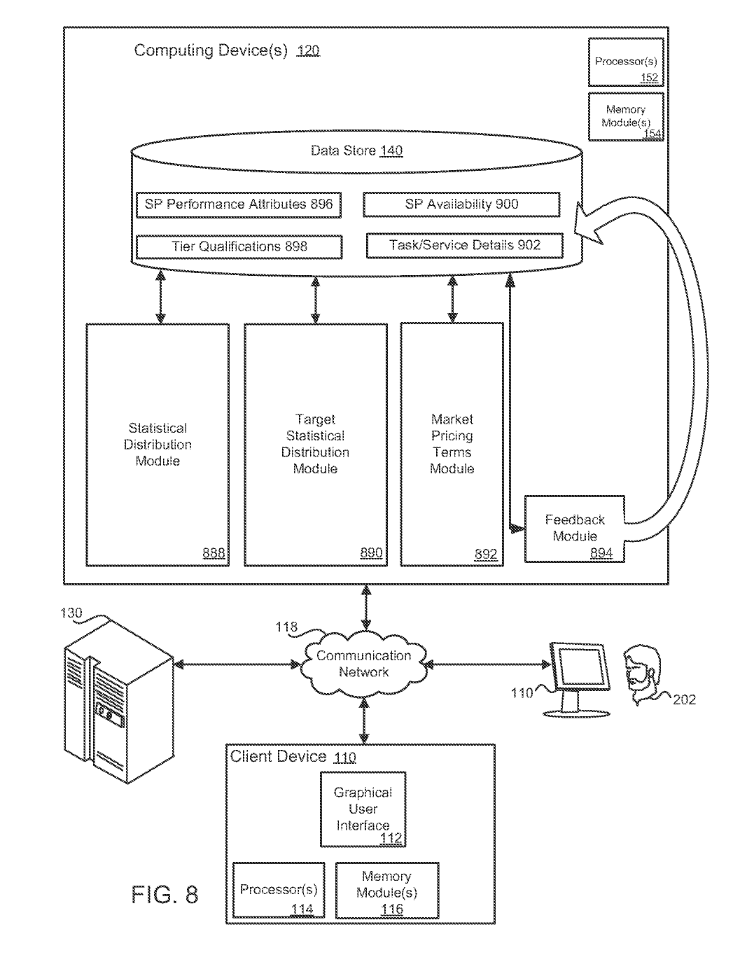

In certain examples, service provider profile 142 information and/or statistical information 150 (FIG. 1) related to a given service provider SP1-SP26 can be collected during pre-screening of a service provider SP1-SP26. Such information can continually be updated. As mentioned earlier, service providers SP1-26 can be expected to perform the one or more of the service options 204a-e by prior agreement. Also, examples of the kind of information that can be gathered are discussed above in relation to FIG. 1 (and below in relation to FIG. 8) within the discussions of service provider profiles 142 and statistical information 150. Without access to such information in the data store 140, a customer 202 may reduplicate the expense, effort, and time associated with gathering this information, often with accompanying inefficiencies arising from a lack of experience with acquiring such information. With respect to a service provider not included in such a data store, large amounts of resources can be wasted in finding customers accessing the data store 140.

As discussed above, service provider profiles 142 can include information about the capabilities of various service providers SP1-SP26 to perform various services. In FIG. 3A, these capabilities are represented by the areas within columns under the various service options 204a-e occupied by the circles and ellipses of the various service providers SP1-SP26. Where a circle or ellipse associated with a given service provider SP1-SP26 occupies an area within a column pertaining to a given service option 204a-e, that service provider SP1-SP26 can be considered capable of performing that service option 204a-e.

For example, the first service provider SP1 is capable of both rekeying locks 204a and evicting a tenant 204b. The second service provider SP2 is only capable of mowing a lawn 204c. However, the third service provider SP3 is capable of mowing a lawn 204c, painting walls 204f, and maintaining a pool 204e. As can be appreciated, although there are 26 service providers SP1-26 depicted in this example, both fewer and greater numbers of service providers are entirely consistent with alternative examples. The storage and computational power provided by the computing device(s) make almost any number of service providers SP1-26 possible.

As indicated by the checkmark, of the several service options 204a-e, a lawn mow is the customer-selected service 204c for the example depicted in FIG. 3A. Therefore, a pooling module 124 similar to the one discussed with respect to FIG. 1 can select from the service providers SP1-26, those service providers SP2, 3, 4, 9, 14, 15, 22, 26 capable of performing the customer-selected service 204c, as indicated by at least a portion of the representative circle or ellipse occupying an area in a column under the customer-selected service 204c. For purposes of illustration, these service providers SP2, 3, 4, 9, 14, 15, 22, 26 are indicated with diagonal cross-hatching. In alternative examples, service providers SP1-SP26 can be pooled on the basis of additional or alternative criteria.

By pooling capable service providers, from pre-screened service providers SP1-SP26 from which information has been gathered, such as, without limitation, information related to service provider profiles 142 and statistical information 150, elements of a market for the customer-selected service 204c can be provided. Providing these initial elements saves a customer 202 significant resources and time otherwise used to pool these service providers SP2, 3, 4, 9, 14, 15, 22, 26. For certain scenarios, this pooling is particularly helpful.

For example, real estate investors often own properties in different states, far from where they live. These properties can be large in number and widely distributed geographically. They can use a large number of varied services to maintain real estate properties. Acquiring information about a minimal number of service providers to address these many and varied service requirements can tax an investor's resources, acquiring information about a large number of service providers can use a prohibitive amount of such resources. In such an example, the service providers SP2, 3, 4, 9, 14, 15, 22, 26 in the pool can also be filtered by geographic location. Availability of the service providers SP2, 3, 4, 9, 14, 15, 22, 26 can provide another non-limiting example of a criterion by which service providers can be pooled, with many other pooling criteria possible.

The pooling capabilities described above can remove the need to expend resources discussed in the previous example. As can be appreciated, although the service options 204a-e can be classified as pertaining to categories of property management, yard services, and home services, all manner of additional categories are consistent with additional examples. For instance, in several examples, services can comprise services used by different types of industrial activities.

FIG. 3A also illustrates examples of sources of information used to generate task details that differentiate levels of work associated with one instance of a particular service as opposed to another. As stated, the circles and ellipses representing the various service providers SP1-SP26 can also include statistical information 150 pertaining to those service providers SP1-SP26. In certain examples, the categories into which this statistical information 150 is subdivided with respect to the various service options 204a-e can provide information about the different levels, or quantities, of work associated with one instance of a particular service as opposed to another. Therefore, in certain examples, the categories into which this statistical information 150 is subdivided can inform the generation of task details 146 similar to the task details 146 discussed with respect to FIG. 1. Additionally, or in the alternative, independent statistical information 306a-e not related to the service provider SP1-SP26, but pertaining to the service options 204a-e can inform the generation of task details 146. In alternative examples, the task details 146 can be obtained independent of such statistical information 150.

Additionally, a customer inquiry module 126 similar to the one discussed earlier (FIG. 1), can use the categories of the task details 146 to generate customer questions 360 for the customer 202 to be communicated over the network 118. Similarly, a query module 128 similar to the one discussed above, can use the categories of the task details 146 to generate a query set 362 for one or more additional sources of information accessible within the data store 140 and/or over the network 118. In examples for which the task details 336 are generated, at least in part, with statistical information from the service providers SP1-SP26, individual questions in the customer questions 360 and individual queries in the query set 362 can be traced to statistical information 150 pertaining to particular service providers SP1-SP26, as indicated in the individual questions and queries in the customer questions 360 and the query set 362. Independent statistical information 306c/ISI pertaining to the customer-selected service 204c can also be traced as a cause for individual questions and queries. Additional details about the customer questions 360 and the query set 362 is discussed with respect to the following figure.

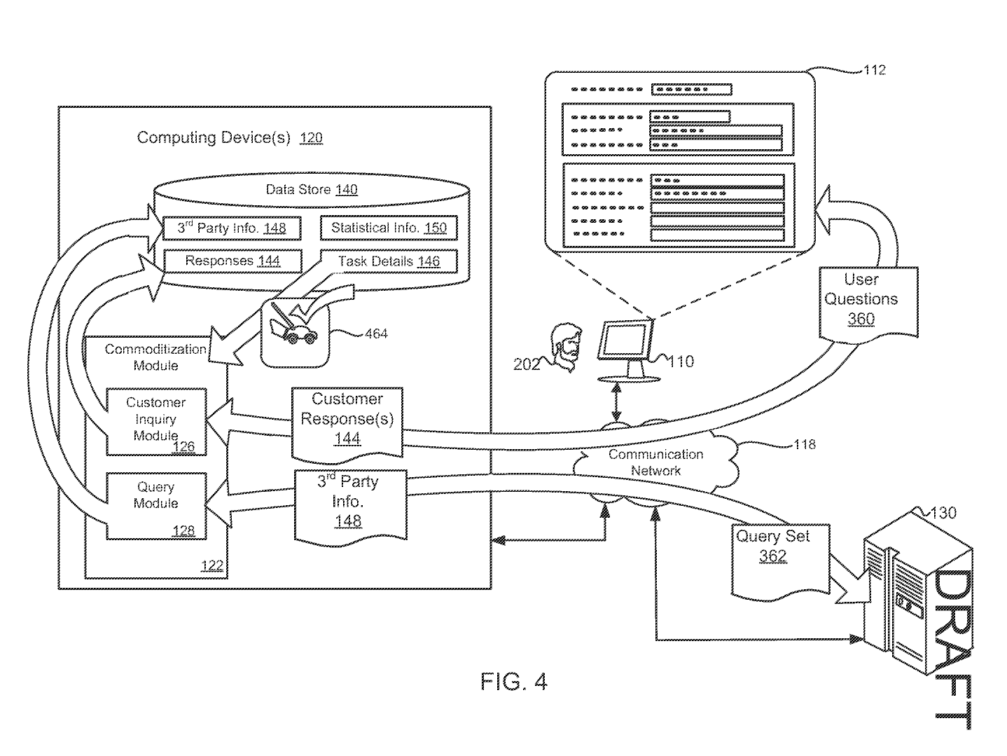

FIG. 4 illustrates an example of acquiring information about a given instance of a customer-selected service used to quantize task details to determine quantities, or levels, of work associated with the given instance of the customer-selected service 204c. The commoditization module 122, within the computing device(s) 120, can apply information to a customer-selected service 204c (FIG. 2) to define values for parameters/variables that can otherwise make amounts of work associated with the customer-selected service indeterminate. The customer inquiry module 126 and the query module 128, which can be in communication with the commoditization module 122 can acquire this information over the communication network.

The commoditization module 122, the customer inquiry module 126, and/or the query module 128, can retrieve a customer-selected service-specific set of task details 464 from the general store of task details 146 in the data store 140. The individual details within the customer-selected service-specific set of task details 464 can define the categories of information for which inquires can be made. Non-limiting examples of such a set of task details 464, where a lawn mow is the customer-selected service 204c, can include the size of the lawn, a number of trees and other obstacles, inclines, sizes of mowers that can be used, contours of lawn perimeters, mowing patterns used, grass thickness, humidity, etc.

In certain examples, the set of task details 464 can include tags indicating whether the information about specific details are likely to be known by the customer 202, or if such information is likely to be obtainable from some other source. In alternative examples, some combination of the commoditization module 122, the customer inquiry module 126, and the query module 128 can be configured to make such determinations. In some examples, a combination of tags within the task details and determinations made by a combination of the commoditization module 122, the customer inquiry module 126, and the query module 128 can be used.

For task details 146 for which a determination is made that the customer 202 is likely to have relevant information, the customer inquiry module 126 can be configured to generate customer questions 360. The customer inquiry module 126 can communicate the customer questions 360 to the customer over the communication network 118. In certain examples, the customer inquiry module 126 can make use of the GUI 112 at the client device 110, as depicted in FIG. 4.

The example GUI 112 in FIG. 4 makes use of a form, with spaces for customer questions and fields for responses. However, many known options for gathering information, such as dropdown boxes, checkboxes, and buttons are consistent with examples. Additionally, the customer inquiry module 126 can send emails, instant messages, text messages, or any other message type that can be sent by the notification module 139 to the customer and/or service provider. In certain examples, the customer inquiry module 126 can generate a webpage to acquire information.

The customer inquiry module 126 can then receive customer response(s) 144 over the communication network 118 from the customer 202 at the client device 110. Customer response(s) 144 can be archived in the data store 140 or applied directly to the set of task details 464 by the commoditization module 122 and/or the customer inquiry module 126.

Similarly, for task details 164 in the set of task details 464 for which a determination is made that one or more additional third-party sources are likely to have relevant information, the query module 128 can be configured to generate a query set 362. The individual queries within the query set can be directed to one or more servers 130 to access private and/or public data files. For example, a house lot size, square footage of the house, number of bedrooms and bathrooms, and related real property information can be obtained online from a real estate information vendor. Similarly, mapping data and address correction data can be obtained from a mapping information vendor. Weather data can be obtained (e.g., without limitation, for snow clearing predictions) including snow accumulation, actual measurements, future predictions, and temperature and humidity for estimating snow ablation from a weather information source.

Another example of a third-party source can include an independent, third-party inspector. The independent, third-party inspector can use a client device 110 to input results of a project inspection preparatory to performing a service comprising the project with the GUI 112. In alternative examples, the independent, third-party inspector can input results over an additional terminal accessible over the network 118. Many additional examples of third-party sources may be used too.

Similar to the query module 128, the customer inquiry module 126 can receive third-party information 148 in response to the query set 362 over the communication network 118. Third-party information 148 can be archived in the data store 140 or applied directly to the set of task details 464 by the commoditization module 122 and/or the query module 128. In addition to applying customer response(s) 144 and/or third-party information 148 to the customer-selected service 204c, a fixed price module 132 can apply statistical information 150 (FIG. 1).

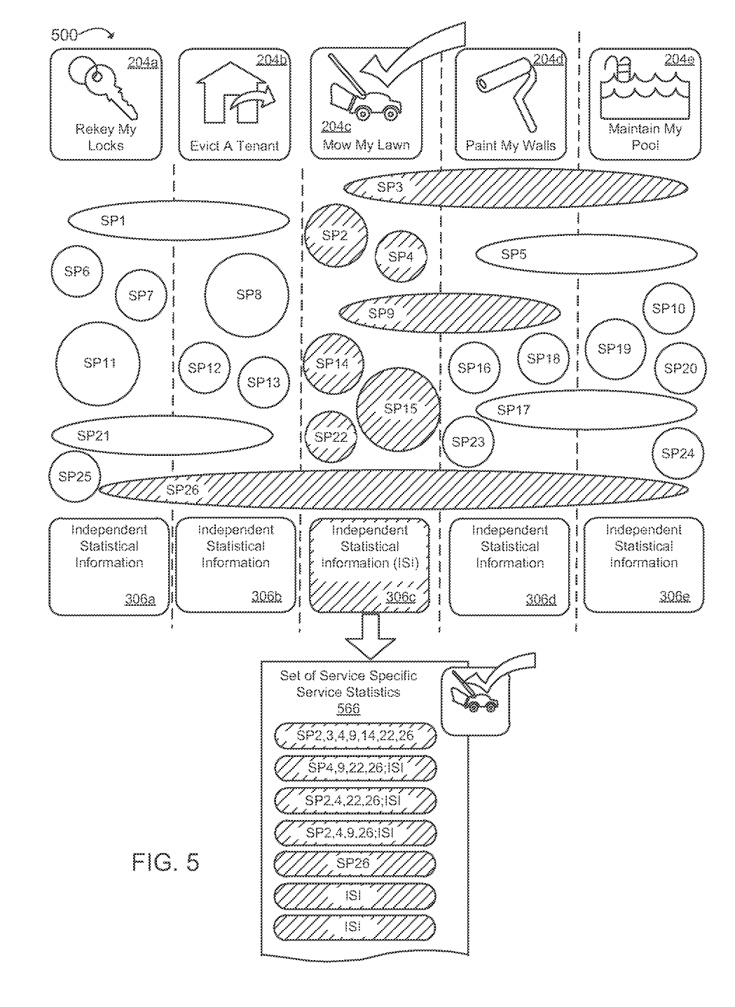

FIG. 5 illustrates an example of compiling statistical information 150 related to the task details 146 for a given customer-selected service 204c from a plurality of service providers. In FIG. 5, several service options 204a-e are placed at the top of a chart 500 including several service providers SP1-SP26. As with FIG. 3A, the circles and ellipses used to represent service providers SP1-SP26 can comprise statistical information 150. The statistical information 150 can pertain to individual service providers SP1-SP26, or the statistical information 150 can pertain to particular service options 204a-e, compiled independently of the service providers SP1-SP26.

In some examples, such service-specific, independent statistical information 306a-e can serve as a source of statistical information 150. In alternative examples, the service-specific, independent statistical information 306a-e can be supplemented with, or replaced by, statistical information 150 associated with specific service providers SP1-SP26. In FIG. 5, the capability of the various service providers SP1-SP26 to perform one or more of the service options 204a-e is represented by the areas within columns under the various service options 204a-e occupied by the circles and ellipses of the various service providers SP1-SP26. Where a circle or ellipse associated with a given service provider SP1-SP26 occupies an area within a column pertaining to a given service option 304a-e, that service provider SP1-SP26 can be considered capable of performing that service option 204a-e.

Therefore, statistical information 150 from the service providers SP2, 3, 4, 9, 14, 15, 22, 26 whose representative circles and ellipses occupy areas within the column under the customer-selected service 204c can comprise statistical information 150 relevant to the customer-selected service 204c. To the extent that such statistical information 150 is present for a service provider SP2, 3, 4, 9, 14, 15, 22, 26, the information can be included in a set of service-specific statistical information 566 compiled for the customer-selected service 204c, indicated in FIG. 5 as a lawn mow by the check mark. For purposes of illustration, service providers SP2, 3, 4, 9, 14, 15, 22, 26 within the column under the customer-selected service 204c, together with the independent statistical information 306c corresponding to the customer-selected service 204c, are indicated with a diagonal crosshatch pattern.

Within the set of service-specific statistical information 566, several units of statistical information are depicted. Each unit of statistical information can include one or more sources for that information, from a service provider SP2, 3, 4, 9, 14, 15, 22, 26 and/or the independent statistical information 306c corresponding to the customer-selected service 204c. For example, the seven units of service-specific statistical information 566 contain statistical information 150 from service providers 2, 3, 4, 9, 14, 22, and 26. The seventh unit of statistical information 566 only contains statistical information 150 from the Independent Statistical Information 206c (ISI) corresponding to the customer-selected service 204c.

Various modules in the computing device(s) 120, including the fixed price module 132, the market price module 134, and the additional price module 136 can parse the independent statistical information 306c into the units of statistical information 150 depicted in the set of service-specific statistical information 566. These units of statistical information 150 can be isolated based on the various units of information available in the independent statistical information 306c. A similar approach can be taken with respect to the derivation of units of statistical information 150 depicted in the set of service-specific statistical information 566 from the statistical information 150 provided for the various service providers SP1-SP26. As explained with reference to the following figure, the set of service-specific statistical information 566 can be used to assign a market price to the customer-selected service 204c.

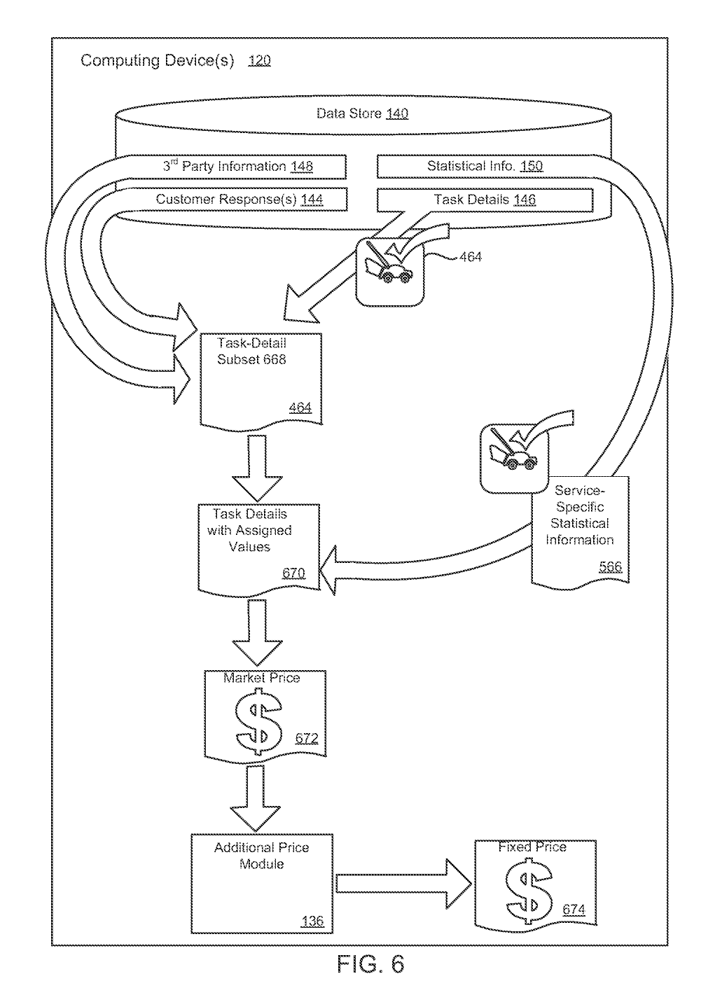

FIG. 6 illustrates an example of using acquired information with statistical pricing information to commoditize a given customer-selected service 204c, assign a market price, and/or a fixed price for the given customer selected service. The commoditization module 122, the customer inquiry module 126, and/or the query module 128 can acquire a task-detail subset 464 from the task details 146 that is specific to the customer-selected service 204c. One or more of these modules can then apply customer response(s) 144 and/or third-party information 148 to this task-detail subset 464. By assigning this acquired information to the task-detail subset 464, potential differences in the amount and/or kinds of work that need to be performed to complete the customer-selected service 204c can be removed. The differentiable customer-selected service 204c can be made undifferentiable, along the lines of a commodity.

Once the parameters/variables of the task-detail subset 464 are assigned values from the customer response(s) 144 and/or the third-party information 148, resulting in task details with assigned values 670, service-specific statistical information 566 can be applied to establish a market price 672. The service-specific statistical information 566 can be selected, retrieved, and/or applied by the fixed price module 132 and/or the market price module 134 to establish a market price 672.

With a market price 672, the customer-selected service 204c can become a virtual commodity and can be treated like a commodity. Service providers stand ready to perform the customer-selected service 204c where the market price 672 is acceptable to a customer 202. However, the market price 672 can lack some considerations for a fixed cost 674, as offered to the customer 202. Accommodation for these considerations can be made by an additional price module 136, which can augment the market price 672 to the fixed price 674 based on these additional considerations. Some of these considerations can be explored with respect to the following figure.

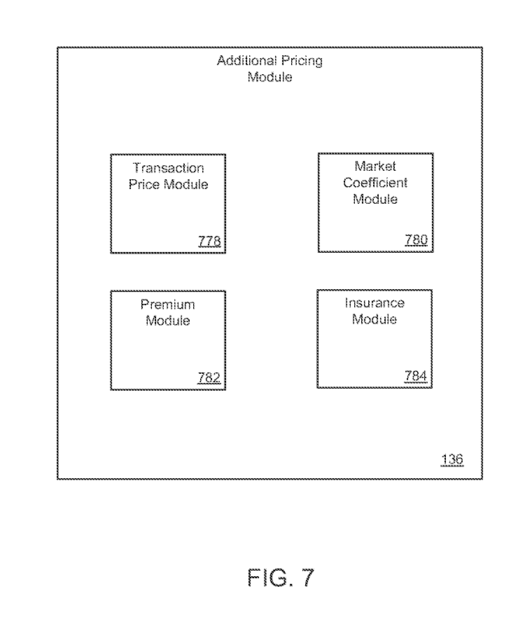

FIG. 7 illustrates an example of additional pricing functionality modules that can be used to adjust a market price 672 for a given customer-selected service 204c to produce a fixed price 674. The additional pricing module 136 is depicted in communication with a transaction price module 778, a market coefficient module 780, a premium module 782, and an insurance module 784. With respect to the transaction price module 778, a percentage can be added to the market price 672 by the transaction price module 778 to be retained by the entity operating the technology described in this description. Non-limiting examples of such retained percentages can range from 1 to 30 percent. However, other percentages are possible and can vary among service options 204a-f.

The market coefficient module 780 can be configured to account for costs pertaining to the customer-selected service 204c specific to different geographic locations. For example, in different geographic regions, the market for wages to which service providers are subject can vary greatly from one geographic region to another. Tax rates imposed on service providers provide another example of a common variable that can vary from region to region. Furthermore, there may be some variables that apply in certain regions, but not others. For example, parking costs can be an issue in a metropolitan area, but not in suburban and rural areas.

To account for these regional cost differences, the market coefficient module 780 can apply a weighted value to the market price 672 and/or market coefficient(s) to service-specific statistical information 566 to result in an appropriately weighted fixed price 674. The market coefficient(s) can be generated with regionally specific statistical information. The application of such market coefficients can be particularly helpful where the service-specific statistical information 566 is generated entirely, or primarily, with independent statistical information 306(c). Service-specific statistical information 566 generated with statistical information 150 from service providers can include some, but not necessarily all, regional considerations.

The premium module 782 provides another example of cost adjustment functionality. The additional premium module 782 can add to and/or deduct from the market price based on additional considerations relevant to the market. For example, an additional schedule constraint for the customer-selected service 204c can result in a premium added to the market price 672 by the premium module 782 in the generation of the fixed price 674. Such schedule constraints can include a time of day or a particular day as a deadline. Further non-limiting examples can include the performance of the customer-selected service 204c on a particular day of the week, a holiday, etc. An example of a discount applied by the premium module 782 can include providing a discount to a given customer 202 where a particular service provider is awarded performance of multiple customer-selected services selected by the customer 202. As can be appreciated, several additional examples of premiums and discounts are consistent with this technology.

The insurance module 784 can apply costs to the market price 762 to address insurance related issues and/or provide a second, and independent, fixed price to address insurance related issues. For example, an additional cost can be provided were a selected and/or assigned service provider is bonded. Additionally, a service can include a separate, but similarly fixed price rate for insurance. Such insurance can include insurance costs for multiple services that a given service provider is capable of performing. Additionally, such insurance can include cover, by way of illustration and not limitation, general liability insurance, workers compensation, occupational accidental insurance, health insurance, and, debt service payments on equipment.

While the present technology provides pricing and quality/performance choices to customers, it does so in many cases by avoiding the conventional bidding process with service providers. One manner of accomplishing this is by pooling or grouping service providers into performance groups, or “tiers.” FIG. 3B illustrates via a block diagram an exemplary tier structure in which Service Providers 37 through 47 (or SP37 through SP47) are pooled into tiers 1 through 5. As is shown, SP 27, SP 38, SP43 and SP 32 are included in the exemplary Tier 1. Similarly, SP37, SP47, SP31 and SP41 are included in Tier 2; SP30, SP29, SP42 and SP45 are included in Tier 3; SP39, SP33, SP46 and SP34 are included in Tier 4; and SP44, SP40, SP35, SP36 and SP28 are included in Tier 5.

While not so required, the various tiers can be ranked in order of desirability, or performance attributes, of the service providers that constitute the tier. Tier 1 may arbitrarily be assigned to the tier having service providers with the highest average performance attributes, with Tiers 2 through 5 descending in rank from that level. The pooling Module 124 (FIG. 1) can be utilized to determine which service providers should be pooled into which tier, based on a number of factors. In one aspect of the invention, factors relating to performance attributes of the service providers can be evaluated to group the providers into tiers, instead of utilizing market price to group the providers.

While the performance attributes considered when pooling service providers into tiers can vary, in one aspect they can include, without limitation, quality of work of the service provider, which can be established via customer feedback or system administrator evaluations. Experience of the service provider can also be considered: e.g., how long the service provider has been in business providing the services in question. Tenure of the service provider within the system can also be considered. User ratings on quality, timeliness, etc., can also be considered, as can audit or evaluation scores on quality, timeliness, etc.

Grouping or pooling the service providers into tiers can be advantageous for a number of reasons. In one particular example, it has been found that, in general, if service providers, or vendors, in a particular tier have higher customer demand than those in other tiers, the availability of those higher-tiered vendors will decrease and price for those vendors should increase. In contrast, if vendors of a particular tier have less customer demand than other quality levels, the availability of those vendors will increase and price for those vendors should decrease.

However, if service providers in a particular tier agree to identical market pricing terms, aspects such as geography, schedule availability, and fair distribution methods can be used as the primary mechanisms for vendor discrimination within a tier, instead of utilizing price. This can be important, as otherwise customers may continue to use price as the driving factor for vendor selection, even within a particular tier, and that might render the present technology incapable of doing such things as (1) assigning the service provider with the best geographic proximity to the customer ordering service; (2) fairly distributing customers amongst service providers in the system over time; and (3) providing increased temporal flexibility for both customers and vendors.

Thus, in one embodiment of the invention, customers are allowed price choices between various tiers, but not within various tiers. Thus, for example, with reference to FIG. 3B, all of the service providers in Tier 1 may agree to accept identical market pricing terms for an equal service or task. All of the service providers in Tier 2 may agree to accept different market pricing terms for the equal service. Customers can be allowed these pricing choices between tiers to ensure that customer demand is apparent for different quality levels of services, thereby allowing the service providers and the system administrator(s) to make adjustments accordingly.

For example, the system might regularly (e.g. once per day at midnight) compute the time differences Dmtvx (where m is the market, t is the tier of service, v is the vendor or service provider, and x is the x^{th} time slot made available to the system by that vendor) between the current time C, and the vendor specified time slots they have made available to the computer system, Smtvx, so Dmtvx=Smtvx−C. Next, the system can compute the mean and standard deviation of these time differences within each tier of service and market.

For each tier of service within each market, if the median time distances minus some number of standard deviations or fraction of a standard deviation, Lσmt (for each tier of service t within each market m, an adjustable parameter), is less than a target time, Tmt (for each tier of service t within each market m, an adjustable parameter), then the price Pmt (for each tier of service t within each market m) can be adjusted downward by some predetermined amount or percentage, LPmt (for each tier of service t within each market m, an adjustable parameter) as Pmt*LPmt=Pmt′ (where P′ is the new price).

For each tier of service within each market, if the median hours minus some number of standard deviations or fraction of a standard deviation, Uσmt (for each tier of service t within each market m, an adjustable parameter), is more than a target time, Tmt (for each tier of service t within each market me, an adjustable parameter), then the price Pmt (for each tier of service t within each market m) can be adjusted up by some predetermined amount or percentage, UPmt (for each tier of service t within each market m, an adjustable parameter) as Pmt*UPmt=Pmt′ (where P′ is the new price).

Generally, for each tier of service in each market, Pmt>Pm[t+1] (where t is a tier of higher quality than the tier [t+1]). This can ensure that there is never an anomaly where a higher quality service task can be procured at a lower price than a lower quality service task of identical size.

In order to prevent a task from being assigned to a vendor at a price deemed too low to be acceptable by the vendor or service provider, an additional filter can be used to remove time slots of some vendors when the price drops below those vendors' acceptable price threshold. When a new vendor is signed up to use the computer system, the vendor can be allowed to provide pricing input for each task they would like to perform. Pricing input can include minimum thresholds at different service levels. These thresholds might be different for every type of task based on the way that pricing is computed and also based on whether there are volume discounts, add-on services, etc. However, regardless of how complex, or how many different types of thresholds exist, if a customer specifies a task to be performed, and the computed price is below the service provider's computed minimum threshold for performing the task, then that service provider can be excluded from the pool of available service providers until the price is recalculated.

This process can provide an additional advantage: that is, when enough service providers are excluded from the computer system, the standard deviation of time differences increases to a large degree, and the pricing algorithm described above will tend toward price increases, resulting in the statistical inclusion of additional vendors because fewer of them will be excluded due to pricing minimums.

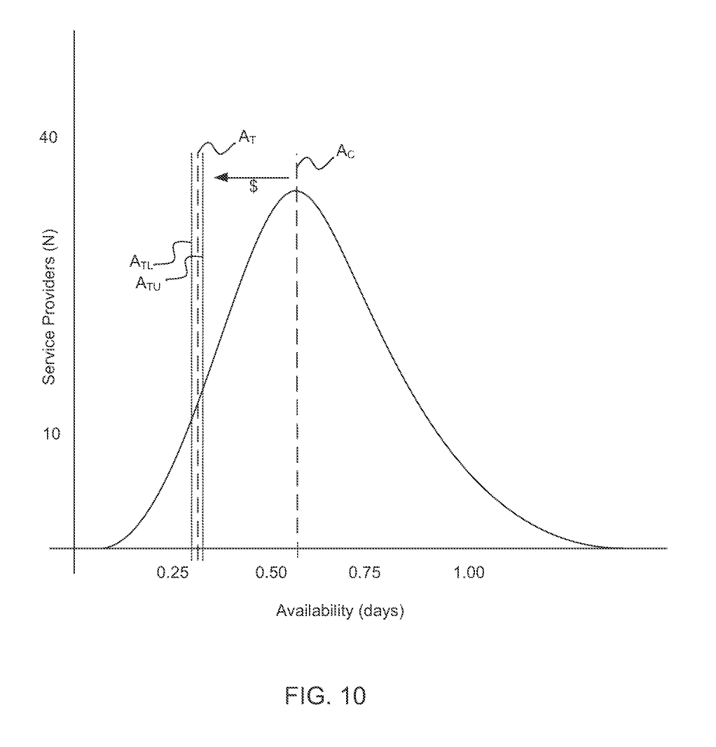

FIG. 10 includes a generalized example of this concept applied only to availability of service providers. In this example, the service providers in a particular tier are plotted against the availability (a statistical distribution of availability) of each service provider. As an arbitrary example, it can be seen that a computed statistical distribution of availability “A_{C}” of the service providers in the aggregate is about 0.6 days. The system, or system administrator(s) may prefer that this availability be reduced in order to limit, for example, wasted “inventory” in the form of open service appointment slots. A more desirable, or target, statistical distribution of availability “A_{T}” may be calculated to be, for example, closer to 0.3 days. The present system can then reduce the pricing terms of all service providers within this particular tier of service providers to thereby cause the actual statistical availability of the service providers to drop, nearing or equaling the target availability.

While the target, or desired, availability “A_{T}” is shown in FIG. 10 as a single value, the present technology may better implement the desired outcome by calculating or establishing the target availability as a range or window of values. For example, an upper target availability (A_{TU}) value and a lower target availability (A_{TL}) value may be calculated or established to define a range or window within which the system can attempt to adjust the actual availability. The statistical adjustment of the actual availability may be better effectuated using a range or a window target.

This process can advantageously be used to adjust for parameters other than pricing structures within particular tiers (or within an aggregated group) of service providers. While the examples discussed herein are directed to utilizing tiers of service providers and statistical analysis to adjust for schedule availability, other parameters may be optimized as well, including geographic parameters, number of service units a service provider has available, etc.

FIG. 8 is a block diagram illustrating an exemplary system that provides one manner in which market pricing terms for a service can be established and/or adjusted. As with FIG. 1, a client device 110, a communication network 118, computing device(s) 120, and a server 130 are included. The client device can include a GUI 112, processor(s) 114, and memory module(s) 116. The computing device(s) 120 include processor(s) 152, memory module(s), and a data store 140, a commoditization module 122, a fixed price module 132, an assignment module 138, and a notification module 139, as in FIG. 1.

Additionally, however, the computing device(s) 120 can also include a statistical distribution module 888, a target statistical distribution module 890, and a market pricing terms module 892. The data store 140 can include information relating to service provider attributes 896, tier qualifications 898, service provider availability 900 and task/service details 902. A feedback module 894 can collect feedback information over the network to provide iterative updating of the various information fields as the modules operate.

The system can be utilized to adjust market pricing terms for a service. The statistical distribution module 888 can determine a statistical distribution of schedule availability (for example, A_{C} in FIG. 10) of a particular tier of service providers (for example, Tier 1 of FIG. 3B). As discussed above, in one example, the service providers grouped or pooled into Tier 1 have all agreed to accept the same market pricing terms for an equal task or service. The service providers will also generally exhibit similar performance attributes as these relate to a particular task or service. As discussed, these factors can all be used by the system to group the service providers into the same tier.

The target statistical distribution module 890 can determine a target statistical distribution (for example, A_{T} in FIG. 10) of schedule availability of service providers of a service. The market pricing terms module 892 can adjust market pricing terms charged by service providers in the particular tier of service providers to adjust the statistical distribution of schedule availability relative to the target statistical distribution of schedule availability. The system can thus modify the actual availability of service providers in the tier to statistically drive the availability toward or to a desired, or target, availability.

In one aspect of the invention, the system can effectuate the change in actual availability through an iterative process. By utilizing the feedback module 894, the system can be cycled through one iteration to adjust the overall availability of the service providers in the tier. After a sufficient amount of time has elapsed, the system can again calculate one or both of the actual availability and the target availability (along with any of the other information types that are deemed beneficial). Market pricing terms can again be adjusted to again drive the actual availability one direction or another by either raising the market pricing terms (which should typically raise the availability) or lowering the market pricing terms (which should lower the availability). This process can be repeated as desired to achieve a particular outcome, or a particular system stability.

In one aspect of the invention, a considerable delay can be implemented into the system to avoid over-adjustment issues which can occur if changes are made too quickly. Thus, the system (and related methods) can include allowing a predetermined amount of time to elapse after adjusting the market pricing terms acceptable by service providers in the particular tier of service providers. This predetermined amount of time can be, for example, two weeks, monthly, every six months, annually, etc. After this time has elapsed, a further iteration can be executed.

In this manner, the system is allowed to stabilize to reflect the changes made in the first iteration before further changes are made. In other words, the system can include processes by which a frequency at which market pricing terms of the tier can be dampened by extending the predetermined amount of time to allow system to stabilize prior to adjusting the market pricing terms again.

In addition to examples described with respect to hardware and modules, several methods consistent with several examples can also be described in relation to the following figures. Such methods can be depicted with functional blocks. These functional blocks can depict steps, or operations, consistent with examples of such methods. Such steps, or operations, can be implemented in computer program code. Although functional blocks can be depicted in order, the order in which they are depicted can, in many instances, be reversed, and does not necessarily indicated a necessary chronological order in which the corresponding steps, or operations, are performed. Several additional methods not depicted can also be consistent with additional examples.

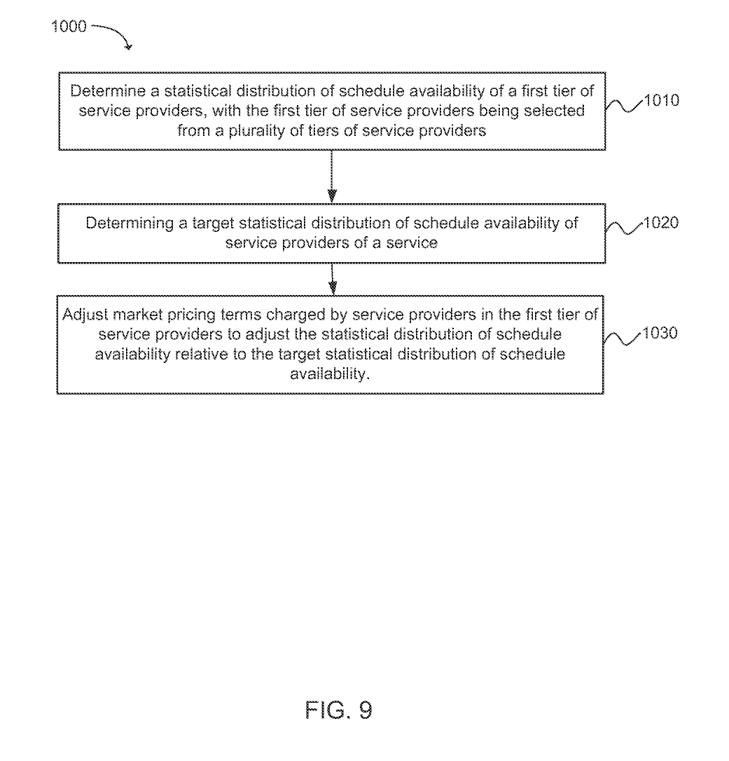

FIG. 9 is a flowchart illustrating a generalized exemplary method 1000 for adjusting market pricing terms for a service. The method can be under control of a processor and memory configured with executable instructions. As shown, at 1010, a statistical distribution of schedule availability of a first tier of service providers can be determined, wherein the first tier of service providers are selected from a plurality of tiers of service providers. At 1020, a target statistical distribution of schedule availability of service providers of a service can be determined. At 1030, market pricing terms charged by service providers in the first tier of service providers are adjusted to adjust the statistical distribution of schedule availability relative to the target statistical distribution of schedule availability. Further methods in accordance with the teachings provided herein, as would occur to one of ordinary skill in the art having possession of this disclosure, are also contemplated and considered a part of this disclosure.

Some of the functional units described in this specification have been labeled as modules, in order to more particularly emphasize their implementation independence. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in software for execution by various types of processors. An identified module of executable code can, for instance, comprise one or more blocks of computer instructions, which can be organized as an object, procedure, or function. Nevertheless, the executables of an identified module need not be physically located together, but can comprise disparate instructions stored in different locations which comprise the module and achieve the stated purpose for the module when joined logically together.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices. The modules can be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein can also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics can be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for adjusting market pricing terms for a service, the method under control of a processor and memory configured with executable instructions, the method comprising:
determining a statistical distribution of schedule availability of a first tier of service providers, the first tier of service providers being selected from a plurality of tiers of service providers;
determining a target statistical distribution of schedule availability of service providers of a service; and
adjusting market pricing terms charged by service providers in the first tier of service providers to adjust the statistical distribution of schedule availability relative to the target statistical distribution of schedule availability.

2. The method of claim 1, wherein members of the plurality of tiers of service providers are pooled into tiers based on factors unrelated to market pricing terms of a service provided by the member service providers.

3. The method of claim 1, wherein members of the plurality of tiers of service providers are pooled into tiers based on performance attributes of services provided by member service providers.

4. The method of claim 3, wherein the performance attributes of services provided are selected from the group consisting of: quality of work of the service provider; experience of the service provider; tenure of the service provider; timeliness of the service provider; user ratings relating to the service provider; and audit findings relating to the service provider.

5. The method of claim 1, wherein market pricing terms that are acceptable by all of the service providers in the first tier of service providers are the same for equal tasks.

6. The method of claim 1, wherein the market pricing terms acceptable by service providers in one of the tiers of service providers are different than the market pricing terms acceptable by service providers in other tiers of service providers for equal tasks.

7. The method of claim 1, wherein adjusting the market pricing terms that are acceptable to service providers in the first tier of service providers, to adjust the statistical distribution of schedule availability relative to the target statistical distribution of schedule availability, comprises lowering the market pricing terms acceptable to the service providers in the first tier of service providers.

8. The method of claim 1, wherein adjusting market pricing terms that are acceptable to service providers in the first tier of service providers, to adjust the statistical distribution of schedule availability relative to the target statistical distribution of schedule availability, comprises raising the market pricing terms acceptable to service providers in the first tier of service providers.

9. The method of claim 1, further comprising allowing a predetermined amount of time to elapse after adjusting the market pricing terms that are acceptable by service providers in the first tier of service providers, then:
determining a second statistical distribution of schedule availability of the first tier of service providers;
determining a second target statistical distribution of schedule availability of service providers of a service; and
adjusting market pricing terms charged by service providers in the first tier of service providers to adjust the second statistical distribution of schedule availability relative to the second target statistical distribution of schedule availability.

10. The method of claim 9, further comprising dampening a frequency at which market pricing terms acceptable by service providers in the first tier of service providers is adjusted by extending the predetermined amount of time to allow the second statistical distribution of schedule availability of the first tier of service providers to stabilize prior to adjusting the market pricing terms.

11. The method of claim 1, further comprising a computer program product comprising a non-transitory computer-usable medium having computer-readable program code adapted to be executed to implement the method for adjusting a market pricing terms for a service.

12. A system for adjusting market pricing terms for a service, comprising:
a statistical distribution module operable to determine a statistical distribution of schedule availability of a first tier of service providers, the first tier of service providers being selectable from a plurality of tiers of service providers;
a target statistical distribution module operable to determine a target statistical distribution of schedule availability of service providers of a service; and
a market pricing terms module operable to adjust market pricing terms charged by service providers in the first tier of service providers to adjust the statistical distribution of schedule availability relative to the target statistical distribution of schedule availability.

13. The system of claim 12, wherein each of the modules resides on a computing device with a computer processor and memory.

14. The system of claim 12, further comprising a pooling module, operable to pool members of the plurality of tiers of service providers into tiers based on factors unrelated to market pricing terms of a service provided by the service providers.

15. The system of claim 12, further comprising a pooling module, operable to pool members of the plurality of service providers into tiers based on performance attributes of services provided by a service provider.

16. The system of claim 15, wherein the performance attributes of services are selected from the group consisting essentially of: quality of work of the service provider; experience of the service provider; tenure of the service provider; timeliness of the service provider; user ratings relating to the service provider; and audit findings relating to the service provider.

17. The system of claim 12, wherein market pricing terms acceptable by all of the service providers in the first tier of service are the same for equal tasks.

18. The system of claim 12, wherein market pricing terms acceptable by service providers in one of the tiers of service providers are different than market pricing terms acceptable by service providers in other tiers of service providers for equal tasks.

19. The system of claim 12, wherein the market pricing terms module adjusts the statistical distribution of schedule availability relative to the target statistical distribution of schedule availability by lowering the market pricing terms acceptable to service providers in the first tier of service providers.

20. The system of claim 12, wherein the market pricing terms module adjusts the statistical distribution of schedule availability relative to the target statistical distribution of schedule availability by raising the market pricing terms acceptable to service providers in the first tier of service providers.
